(19) United States
(12) Patent Application Publication
(10) Pub. No.: US 2016/0242189 A1
(43) Pub. Date: Aug. 18, 2016

(54) COMMUNICATION APPARATUS FOR EARTH STATION AND TRANSMISSION FREQUENCY BAND ALLOCATION METHOD

(71) Applicant: Electronics and Telecommunications Research Institute, Daejeon (KR)

(72) Inventors: Dae Sub OH, Daejeon (KR); Un Hee PARK, Daejeon (KR); Dae Ig CHANG, Daejeon (KR)

(21) Appl. No.: 15/043,030

(22) Filed: Feb. 12, 2016

(30) Foreign Application Priority Data
Feb. 13, 2015 (KR) 10-2015-0022160

(51) Int. Cl. H04W 72/08; H04W 72/04; H04B 7/14

(52) U.S. Cl. CPC H04W 72/082; H04B 7/14; H04W 72/0453

(57) ABSTRACT

A communication apparatus of an earth station to avoid frequency interference with a terrestrial communication system is provided. The communication apparatus may include a signal extractor configured to acquire a signal of a terrestrial radio station by cancelling a signal transmitted by the earth station from received signals, a detector configured to detect an interference state between a satellite communication network and a terrestrial communication network by comparing a signal strength of the signal of the terrestrial radio station to a predetermined interference signal threshold, and a frequency allocator configured to allocate a new frequency slot to be used by the earth station to transmit a signal, when the detector detects the interference state.

### CROSS-REFERENCE TO RELATED APPLICATION

This application claims the benefit of Korean Patent Application No. 10-2015-0022160, filed on Feb. 13, 2015, in the Korean Intellectual Property Office, the disclosure of which is incorporated herein by reference.

### BACKGROUND

1. Field of the Invention

The following embodiments relate to a communication apparatus of an earth station, and more particularly, to a structure for determining a dynamic satellite link channel of a communication apparatus of an earth station to avoid frequency interference with a terrestrial communication system, and a structure for allocating a transmission frequency band.

2. Description of the Related Art

In a satellite communication network, a Demand Assigned Multiple Access (DAMA) scheme to allocate frequency resources is used. In the DAMA scheme, an appropriate frequency slot is allocated to an earth station for the satellite communication network for a communication with a space station for the satellite communication network, and the earth station communicates with the space station and returns the frequency slot. Different bandwidths of allocated frequency slots may be determined based on an amount of information (for example, sound, facsimile data, video, data, or communication data) transmitted by the earth station. However, because a limited frequency band is shared between the satellite communication network and a terrestrial communication network, frequency interference between the satellite communication network and the terrestrial communication network would occur. According to a related art, an interference avoiding method using a physical environment, for example, geographical isolation or securing a proper separation distance between a satellite communication network and a terrestrial communication network, has been introduced. However, it is difficult to apply the interference avoiding method to all general frequency sharing environments between a satellite communication network and a terrestrial communication network. In addition, a method of using a satellite communication network and a terrestrial communication network by dividing a frequency band has been provided, however, a spectral efficiency is relatively low.

### SUMMARY

According to an aspect, there is provided a communication apparatus of an earth station. The communication apparatus may include at least one processor and may be at least temporarily implemented by the at least one processor. The least one processor may include a signal extractor configured to acquire a signal of a terrestrial radio station by cancelling a signal transmitted by the earth station from received signals, a detector configured to detect an interference state between a satellite communication network and a terrestrial communication network by comparing a signal strength of the terrestrial radio station to a predetermined interference signal threshold, and a frequency allocator configured to allocate a new frequency slot to be used by the earth station to transmit a signal, when the detector detects the interference state. The communication apparatus may further include a communicator configured to monitor signals transmitted and received in a whole frequency band used by the earth station.

The detector may be configured to compare a signal strength of each of signals of the terrestrial radio station corresponding to each frequency slot to the interference signal threshold, and the frequency allocator may be configured to allocate a frequency slot from which the interference state is not detected to the earth station so that the earth station transmits a signal. The frequency allocator may be configured to allocate a frequency slot corresponding to a minimum signal strength of the terrestrial radio station to the earth station so that the earth station transmits a signal.

The detector may be configured to set the interference signal threshold based on surrounding information. The surrounding information may include geographic information, neighboring building information, location information of a terrestrial radio station, atmospheric environment information and a performance of the communication apparatus.

The communicator may include an antenna device directed towards a space station at an elevation angle in a horizontal direction, and configured to transmit and receive a communication signal for the satellite communication network, and an interference signal receiving device directed in the horizontal direction, and configured to receive a signal component of the terrestrial radio station in the same frequency band as a frequency band of the communication signal. The interference signal receiving device may be configured to receive a leak component of a signal from the earth station. The signal extractor may be configured to acquire the signal of the terrestrial radio station by cancelling a signal transmitted by the space station from the communication signal.

According to another aspect, there is provided a method of avoiding interference between a satellite communication network and a terrestrial communication network. The method may include receiving all signals in a frequency band used by the satellite communication network, extracting a signal associated with the terrestrial communication network by cancelling a signal associated with the satellite communication network from the signals, and detecting an interference state between the satellite communication network and the terrestrial communication network by comparing a signal strength of the extracted signal to an interference signal threshold. The extracting may include cancelling both a signal transmitted by an earth station and a signal transmitted by a space station as signals associated with the terrestrial communication network.

The detecting may include, when the signal strength of the extracted signal is greater than the interference signal threshold, detecting the interference state. The detecting may include comparing a signal strength associated with the terrestrial communication network for each of frequency slots included in the frequency band to the interference signal threshold. The detecting may include determining the interference signal threshold based on geographic information, neighboring building information, location information of a terrestrial radio station, atmospheric environment information and a performance of a communication apparatus.

The method may further include calculating a frequency slot corresponding to a minimum signal strength associated with the terrestrial communication network, and newly allocating the frequency slot to the satellite communication network so that the frequency slot is preferentially used by the satellite communication network, when the interference state is detected.

The receiving may include newly receiving the signals in real time or based on a predetermined period. The detecting may include, when the signals are newly received, newly detecting the interference state.

According to another aspect, there is provided an interference signal receiving device. The interference signal receiving device may include at least one processor configured to separate a signal of a terrestrial radio station from received signals, to analyze information about usage of each of frequency slots in which the signal of the terrestrial radio station is being transmitted and received, and to allocate a frequency slot for minimum frequency interference among the frequency slots to a satellite communication network signal. The at least one processor may be configured to analyze information about usage of the frequency slots by comparing a signal strength of the terrestrial radio station corresponding to the frequency slot to a predetermined threshold. The at least one processor may be configured to allocate the frequency slots to the satellite communication network signal in an ascending order of signal strengths of the terrestrial radio station.

The interference signal receiving device may further include a communicator configured to transmit and receive the satellite communication network signal and to receive a terrestrial communication network signal. The communicator may be configured to receive a leak component of a transmitted signal, and the at least one processor may be configured to cancel the leak component and to separate the signal of the terrestrial radio station.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a communication apparatus of an earth station for a satellite communication network according to an embodiment;

FIGS. 2A and 2B illustrate a Demand Assigned Multiple Access (DAMA) scheme to allocate frequency resources in a satellite communication network according to an embodiment;

FIGS. 3A and 3B illustrate a radio frequency interference state between a satellite communication network and a terrestrial communication network according to an embodiment;

FIG. 4 is a graph illustrating an operation of detecting an interference state between a satellite communication network and a terrestrial communication network according to an embodiment;

FIG. 5 is a graph illustrating an example of allocating a new frequency slot to be used by a satellite communication network to avoid interference according to an embodiment; and

FIG. 6 illustrates a method of avoiding frequency interference between a satellite communication network and a terrestrial communication network according to an embodiment.

### DETAILED DESCRIPTION

Hereinafter, some embodiments will be described in detail with reference to the accompanying drawings. The present disclosure, however, should not be construed as limited to the embodiments set forth herein. Regarding the reference numerals assigned to the elements in the drawings, it should be noted that the same elements will be designated by the same reference numerals.

Also, terms used herein are selected from general terms being used in the related arts. Yet, the meanings of the terms used herein may be changed depending on a change and/or development of technologies, a custom, or preference of an operator in the art. Accordingly, the terms are merely examples to describe the embodiments, and should not be construed as limited to the technical idea of the present disclosure.

In addition, in a specific case, most appropriate terms are arbitrarily selected by the applicant for ease of description and/or for ease of understanding. In this instance, the meanings of the arbitrarily used terms will be clearly explained in the corresponding description. Hence, the terms should be understood not by the simple names of the terms but by the meanings of the terms and the following overall description of this specification.

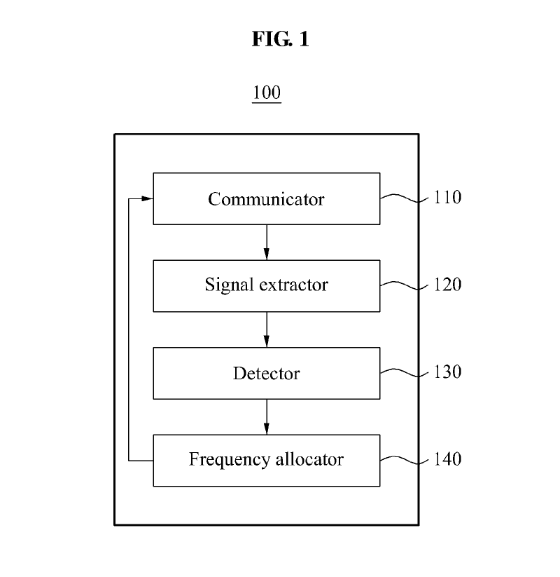

FIG. 1 is a block diagram illustrating a communication apparatus 100 for an earth station for a satellite communication network according to an embodiment. Hereinafter, the earth station for the satellite communication network may be referred to as an “earth station.”

The communication apparatus 100 may include a communicator 110, a signal extractor 120, a detector 130 and a frequency allocator 140. The communicator 110 may receive and monitor signals of a predetermined frequency band. The predetermined frequency band may be, for example, a whole frequency band used by the satellite communication network. The communicator 110, the signal extractor 120, the detector 130 and the frequency allocator 140 may be included in at least one processor and may be at least temporarily implemented by the at least one processor.

The communicator 110 may include at least one receiving device. The at least one receiving device may comprise a receiving device having an elevation angle from a horizontal plane. The receiving device may be installed in a direction perpendicular to the horizontal plane. For example, a receiving device having an elevation angle from a horizontal plane may receive a signal from a space station for the satellite communication network (hereinafter, referred to as a “space station”). The receiving device may be installed at an elevation angle with a highest rate of transmission from the space station based on geographic information, a communication state, and the like.

The at least one receiving device may be directed in a horizontal direction. For example, a receiving device directed in the horizontal direction may receive a terrestrial communication network signal. The receiving device directed in the horizontal direction may receive a terrestrial communication network signal with a high reception efficiency in comparison to a receiving device having an elevation angle from a horizontal plane. The communicator 110 may receive a leak component of a signal transmitted by the earth station to a space station.

The signal extractor 120 may acquire a signal of a radio station for a terrestrial communication network by cancelling a signal transmitted by the earth station from received signals. Hereinafter, the radio station for the terrestrial communication network may be referred to as a “terrestrial radio station.” Because the communication apparatus 100 is connected to the earth station, the communication apparatus 100 may acquire information about a signal transmitted by the earth station. The signal extractor 120 may cancel a component of the signal transmitted by the earth station from signals received by the communicator 110, and may acquire a component of the signal of the terrestrial radio station.

The signal extractor 120 may cancel, from the received signals, a signal component that is transmitted by the space station and that is received by the earth station, and may acquire a signal of the terrestrial radio station. As described above, a specific receiving device installed at an elevation angle may have a higher reception efficiency in a direction of the space station. The signal extractor 120 may extract information that is transmitted by the space station and that is received by the earth station, based on information of a signal received by the specific receiving device. The signal extractor 120 may cancel, from the received signals, a signal that is transmitted by the space station and that is received by the earth station, and may acquire a signal component of the terrestrial radio station. In addition, the earth station may receive a leak signal in information that is transmitted from the earth station to the space station, and the signal extractor 120 may cancel the received leak signal and may acquire the signal component of the terrestrial radio station.

The detector 130 may compare a signal strength of the terrestrial radio station to a predetermined interference signal threshold, and may detect an interference state between the satellite communication network and the terrestrial communication network. For example, the detector 130 may compare a signal strength of each of signals of the terrestrial radio station corresponding to each of frequency slots to the interference signal threshold. The frequency slots may be included in a frequency band used by the satellite communication network. The detector 130 may detect an interference state for each of signals of the terrestrial radio station corresponding to each of frequency slots with respect to the satellite communication network.

The detector 130 may set the interference signal threshold based on surrounding information. The interference signal threshold may be a reference value used to determine an interference state when the same frequency band is used by a satellite communication network signal and a terrestrial communication network signal. In an example, when a signal strength of a received signal of the terrestrial radio station is less than the interference signal threshold, the terrestrial radio station may be interpreted to operate in a great distance from a transmitting device of the earth station. Thus, it may be determined that there is no interference effect or that an interference effect is negligible.

In another example, when the signal strength of the terrestrial radio station is greater than the interference signal threshold, the earth station and the terrestrial radio station may interfere with each other. In this example, the detector 130 may set a proper interference signal threshold to detect an interference state based on geographic information, neighboring building information, location information of the terrestrial radio station, atmospheric environment information and a performance of a communication system for the earth station.

When the detector 130 detects the interference state, the frequency allocator 140 may allocate a new frequency slot that is to be used by the earth station to transmit a signal. For example, the frequency allocator 140 may preferentially allocate a frequency slot from which the interference state is not detected to the earth station so that the earth station may transmit a signal. Also, the frequency allocator 140 may preferentially allocate a frequency slot corresponding to a minimum signal strength of the terrestrial radio station to the earth station so that the earth station may transmit a signal. The above-described frequency slots may be included in the frequency band used by the satellite communication network.

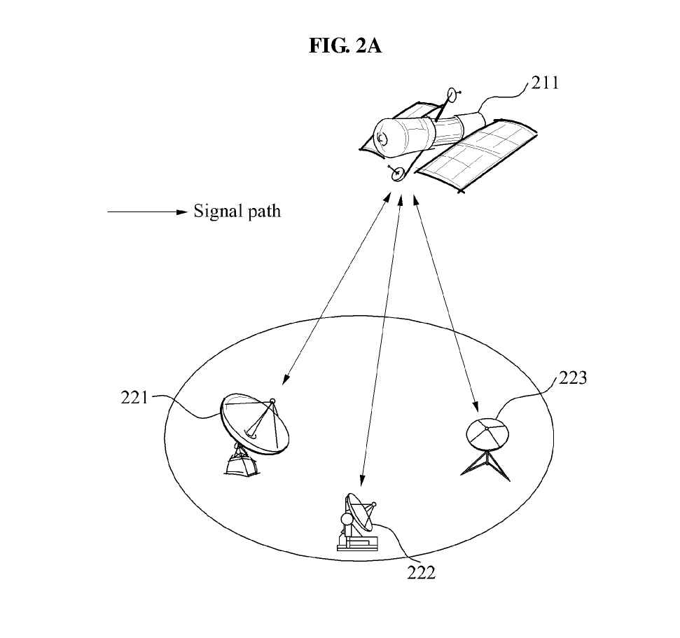

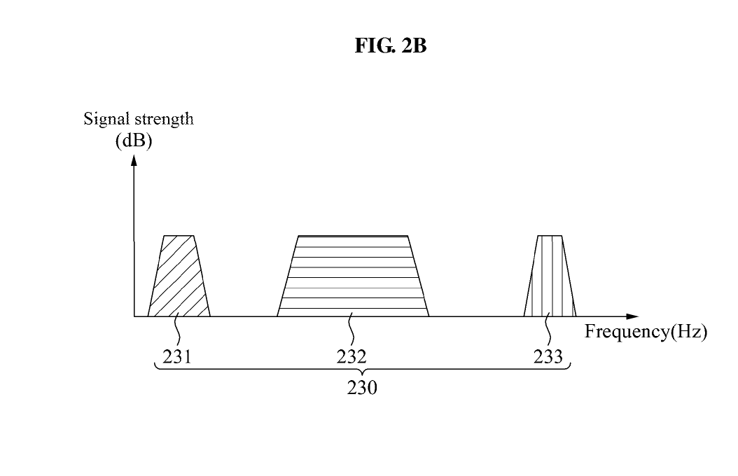

FIGS. 2A and 2B illustrate a Demand Assigned Multiple Access (DAMA) scheme to allocate frequency resources in a satellite communication network according to an embodiment.

Referring to FIG. 2A, a communication system of the satellite communication network may include a space station 211 for the satellite communication network, and earth stations 221, 222 and 223 for the satellite communication network. Signals may be transmitted and received between the space station 211 and the earth stations 221, 222 and 223. To prevent interference from occurring in signals, a portion of a frequency band used by the satellite communication network may be allocated to each of the earth stations 221, 222 and 223.

Referring to FIG. 2B, a frequency bandwidth 230 used by a communication system of the satellite communication network may include at least one frequency slot, for example, frequency slots 231, 232 and 233. Based on the DAMA scheme, the frequency slots 231, 232 and 233 may be allocated to the earth stations 221, 222 and 223, respectively. The above corresponding relationship between the earth stations 221, 222 and 223 and the frequency slots 231, 232 and 233 may be variable, not permanent. In the DAMA scheme, the earth stations 221, 222 and 223 may continue to use and return a portion of the frequency band. Different frequency slots may be determined based on an amount of information transmitted and received by each of the earth stations 221, 222 and 223. Accordingly, a bandwidth and a central frequency of frequency resources corresponding to the earth stations 221, 222 and 223 may change.

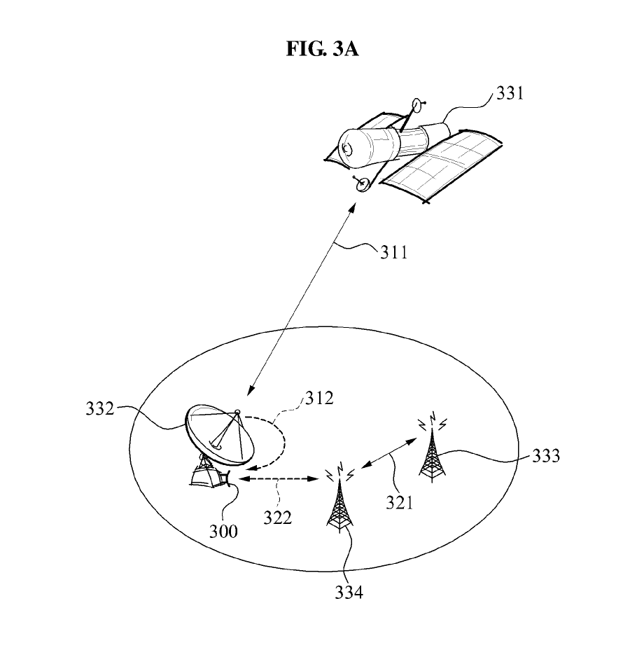

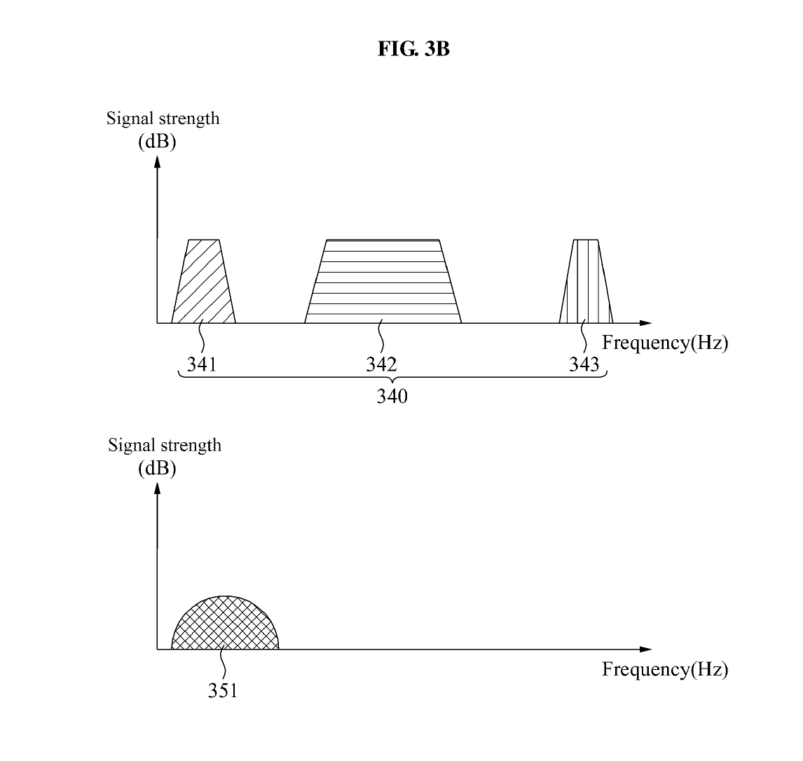

FIGS. 3A and 3B illustrate a radio frequency interference state between a satellite communication network and a terrestrial communication network according to an embodiment.

FIG. 3A illustrates a communication apparatus 300 of an earth station, an space station 331, an earth station 332, and terrestrial radio stations 333 and 334. The communication apparatus 300 may receive and monitor all signals in a predetermined frequency band. The signals may include a signal 311 between the space station 331 and the earth station 332, a leak signal 312 corresponding to a leak component transmitted by the earth station 332, and a signal 321 between the terrestrial radio stations 333 and 334. The communication apparatus 300 may include a communicator, and the communicator may include at least one receiving device. For example, a first receiving device may be installed at an elevation angle from a horizontal plane, and may receive the signal 311 from the space station 331. Also, a second receiving device may be installed in a horizontal direction, and may receive a terrestrial communication network signal 322 from the terrestrial radio station 334.

Among signals received by the earth station 332, the leak signal 312 and the terrestrial communication network signal 322 other than the signal 311 received from the space station 331 may correspond to interference signals. For example, for detection of interference signals, the signal extractor 120 of FIG. 1 may cancel the leak signal 312 as well as the signal 311, and may acquire the terrestrial communication network signal 322. To more accurately detect an interference state of the terrestrial radio stations 333 and 334, the leak signal 312 corresponding to the leak component transmitted by the earth station 332 may also be cancelled.

Referring to FIG. 3B, a frequency band 340 used by the satellite communication network may include frequency slots 341, 342 and 343. The signal 311 may be transmitted and received using the frequency slot 341 between the space station 331 and the earth station 332. The signal 321 may be transmitted and received using a frequency slot 351 between the terrestrial radio stations 333 and 334. The frequency slot 341 used by the satellite communication network may overlap the frequency slot 351 used by the terrestrial communication network, as shown in FIG. 3B, which may lead to a radio frequency interference phenomenon. The communication apparatus 300 may detect a signal transmission quantity of the terrestrial radio stations 333 and 334 and an interference state between the satellite communication network and the terrestrial communication network for each frequency slot based on a received signal 321 corresponding to the signal 322 between the terrestrial radio stations 333 and 334. The above detecting operation may be performed by the detector 130 of FIG. 1.

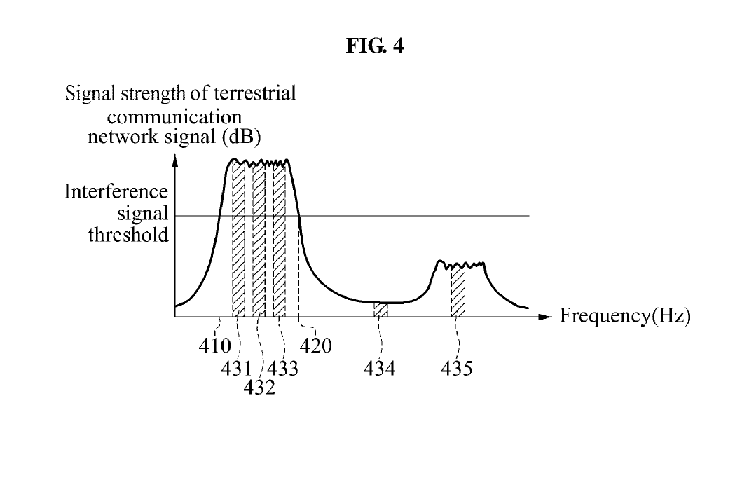

FIG. 4 is a graph illustrating an operation of detecting an interference state between a satellite communication network and a terrestrial communication network according to an embodiment.

A signal strength of each of signals transmitted and received between terrestrial radio stations may be determined based on a frequency band. For example, a detector of a communication apparatus of an earth station may compare a signal strength of a terrestrial radio station to a predetermined interference signal threshold, and may detect the interference state between the satellite communication network and the terrestrial communication network. Referring to FIG. 4, the detector may detect an interference state between the satellite communication network and the terrestrial communication network when a signal strength of a terrestrial communication network signal is greater than the interference signal threshold. In FIG. 4, the detector may detect the interference state from a frequency band between frequencies 410 and 420.

In another example, the detector may compare a signal strength of each of signals of the terrestrial radio station corresponding to each of frequency slots included in a frequency band used by the satellite communication network to the interference signal threshold, and may detect the interference state. When a signal strength of each of the signals of the terrestrial radio station corresponding to each of the frequency slots is greater than the interference signal threshold, the detector may detect the interference state from a corresponding frequency slot. As shown in FIG. 4, a signal strength of each of terrestrial communication network signals corresponding to each of frequency slots 431, 432, 433, 434 and 435 may be compared to the interference signal threshold. It is found that a signal strength of each of terrestrial communication network signals corresponding to the frequency slots 431, 432 and 433 is greater than the interference signal threshold, and that a signal strength of each of terrestrial communication network signals corresponding to the frequency slots 434 and 435 is less than the interference signal threshold. Thus, the interference state may be detected from the frequency slots 431, 432 and 433, and may not be detected from the frequency slots 434 and 435.

As shown in FIG. 4, the signal strengths of the terrestrial communication network signals transmitted and received using the frequency slots 434 and 435 may exceed the interference signal threshold. The detector may detect the interference state between the satellite communication network and the terrestrial communication network based on the signals transmitted and received using the frequency slots 434 and 435. When the interference state is detected, a frequency allocator may allocate the frequency slots 434 and 435, from which the interference state is not detected, to the earth station so that the earth station may transmit a signal.

The frequency allocator may preferentially allocate a frequency slot corresponding to a minimum signal strength of the terrestrial radio station to the earth station so that the earth station may transmit a signal. As shown in FIG. 4, a signal strength of a terrestrial communication network signal transmitted and received using the frequency slot 434 is less than a signal strength of a terrestrial communication network signal transmitted and received using the frequency slot 435. Here, the frequency allocator may preferentially allocate the frequency slot 434 to the earth station. The frequency allocator may detect and store a signal strength of the terrestrial radio station corresponding to each frequency slot. For example, when an interference state is not detected from a plurality of frequency slots, the frequency allocator may preferentially allocate a frequency slot corresponding to a minimum signal strength of the terrestrial radio station to the earth station.

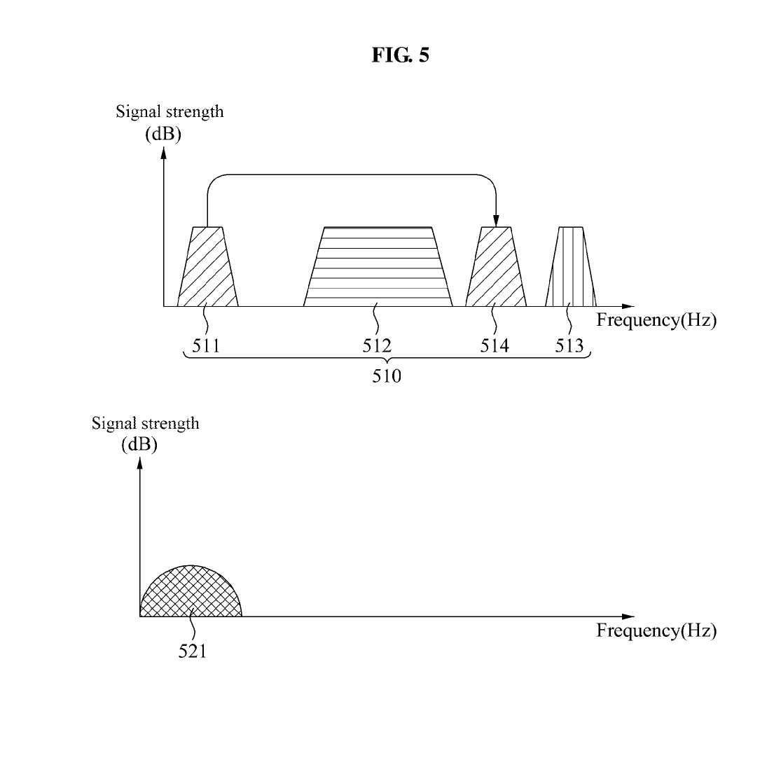

FIG. 5 is a graph illustrating an example of allocating a new frequency slot to be used by a satellite communication network to avoid interference according to an embodiment.

For example, when a detector detects an interference state, a frequency allocator may allocate a new frequency slot to be used by an earth station to transmit signal. Referring to FIG. 5, a frequency band 510 used by the satellite communication network may include at least one frequency slot, for example, frequency slots 511, 512, 513 and 514. The frequency slot 511 may overlap a frequency slot 521 used by a terrestrial radio station. The detector may detect the interference state from the frequency slot 511, as described above. The frequency allocator may analyze information about usage of a frequency slot used by the satellite communication network, in real time or at predetermined intervals. In FIG. 5, the frequency slot 514 that is not currently used by another earth station among the frequency slots 511 through 514 may be allocated. Accordingly, the frequency allocator may newly allocate the frequency slot 514 as a frequency slot used by the satellite communication network.

The frequency allocator may allocate the frequency slots 511 through 514 using the DAMA scheme. In FIG. 5, the frequency slot 514 that is not currently used by the satellite communication network may be allocated, however, the allocated frequency slot may be returned when a communication ends. For example, when the interference state is detected and the frequency slot 513 is not currently used, the frequency slot 513 may be allocated as a new frequency slot to be used by the satellite communication network. Also, when the interference state is detected and the frequency slot 512 is not currently used, the frequency slot 512 may be allocated as a new frequency slot to be used by the satellite communication network.

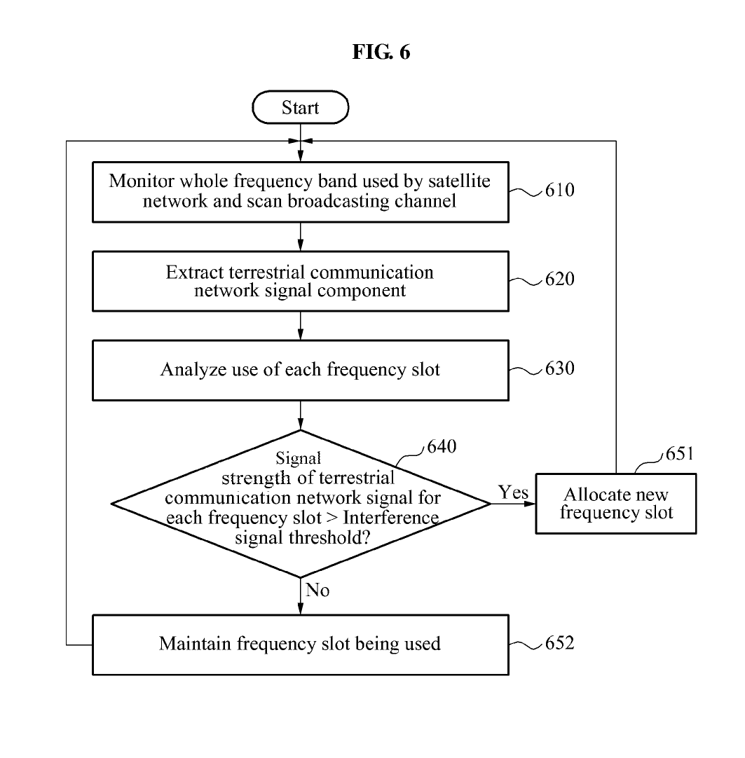

FIG. 6 illustrates a method of avoiding frequency interference between a satellite communication network and a terrestrial communication network according to an embodiment.

Referring to FIG. 6, in operation 610, the whole frequency band used by the satellite communication network may be monitored. As described above, all signals transmitted and received in the frequency band may be received. In operation 610, a receiving device may be installed in a more suitable location to receive a satellite communication network signal or a terrestrial communication network signal. In an example, when the receiving device is installed at an elevation angle equal to or greater than 45° from a horizontal plane, a high reception efficiency of a signal transmitted from a space station may be expected. In another example, when the receiving device is installed at an elevation angle equal to or less than 45° from a horizontal plane, a high reception efficiency of a signal transmitted from a terrestrial radio station may be expected.

In operation 620, a terrestrial communication network signal component may be extracted from all the received signals. For example, a signal transmitted by an earth station may be cancelled from all the received signals and a terrestrial communication network signal component may be extracted. In an example, in operation 620, information about a signal transmitted by the earth station in a satellite communication system may be stored, the stored information may be removed from the received signals, and the terrestrial communication network signal component may be extracted. In another example, in operation 620, a received satellite communication network signal may be removed, and a terrestrial communication network signal may be acquired. The received satellite communication network signal may include a signal component transmitted from the space station, and a leak component of a signal transmitted by the earth station.

In operation 630, use of each frequency slot may be analyzed. In operation 640, an interference state may be detected for each frequency slot. In operation 630, a signal strength of a satellite communication network signal corresponding to a frequency slot may be calculated. A frequency slot that is being used in the satellite communication system, and a frequency slot that is not used in the satellite communication system may be detected. An amount of the frequency slot that is being used may be calculated.

In operation 640, a signal strength of a terrestrial communication network signal for each frequency slot is compared to an interference signal threshold, and an interference state may be detected. A process of setting an interference signal threshold has been described above, and accordingly further description of the process is omitted. A signal strength of a terrestrial communication network signal corresponding to a frequency slot may be compared to the interference signal threshold. When the signal strength of the terrestrial communication network signal is greater than the interference signal threshold, the interference state may be detected. Based on a definition of the interference state, when the signal strength of the terrestrial communication network signal is equal to the interference signal threshold, the interference state may be detected.

Operations 651 and 652 may be performed based on whether the interference state is detected. When the interference state is detected, a new frequency slot may be allocated to the earth station in operation 651. Operation 651 may be the same as the above-described operation of the frequency allocator, and accordingly further description thereof is omitted. When the interference state is not detected, the satellite communication network may be used while maintaining a frequency slot that is being used in operation 652. The method of FIG. 6 may be performed in real time or periodically. Accordingly, the method of FIG. 6 may revert to operation 610 to continue to detect the interference state, to avoid the frequency interference.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A communication apparatus of an earth station, the communication apparatus comprising at least one processor and being at least temporarily implemented by the at least one processor,
wherein the least one processor comprising:
a signal extractor configured to acquire a signal of a terrestrial radio station by cancelling a signal transmitted by the earth station from received signals;
a detector configured to detect an interference state between a satellite communication network and a terrestrial communication network by comparing a signal strength of the signal of the terrestrial radio station to a predetermined interference signal threshold; and
a frequency allocator configured to allocate a new frequency slot to be used by the earth station to transmit a signal, when the detector detects the interference state.

2. The communication apparatus of claim 1, further comprising:
a communicator configured to monitor signals transmitted and received in a whole frequency band used by the earth station.

3. The communication apparatus of claim 1, wherein the detector is configured to compare a signal strength of each of signals of the terrestrial radio station corresponding to each frequency slot to the interference signal threshold, and
wherein the frequency allocator is configured to allocate a frequency slot from which the interference state is not detected to the earth station so that the earth station transmits a signal.

4. The communication apparatus of claim 3, wherein the frequency allocator is configured to allocate a frequency slot corresponding to a minimum signal strength of the terrestrial radio station to the earth station so that the earth station transmits a signal.

5. The communication apparatus of claim 1, wherein the detector is configured to set the interference signal threshold based on surrounding information, and
wherein the surrounding information comprises geographic information, neighboring building information, location information of a terrestrial radio station, atmospheric environment information and a performance of the communication apparatus.

6. The communication apparatus of claim 2, wherein the communicator comprises:
an antenna device directed towards a space station at an elevation angle in a horizontal direction, and configured to transmit and receive a communication signal for the satellite communication network; and
an interference signal receiving device directed in the horizontal direction, and configured to receive a signal component of the terrestrial radio station in the same frequency band as a frequency band of the communication signal.

7. The communication apparatus of claim 6, wherein the interference signal receiving device is configured to receive a leak component of a signal from the earth station.

8. The communication apparatus of claim 6, wherein the signal extractor is configured to acquire the signal of the terrestrial radio station by cancelling a signal transmitted by the space station from the communication signal.

9. A method of avoiding interference between a satellite communication network and a terrestrial communication network, the method comprising:
receiving all signals in a frequency band used by the satellite communication network;
extracting a signal associated with the terrestrial communication network by cancelling a signal associated with the satellite communication network from the signals; and
detecting an interference state between the satellite communication network and the terrestrial communication network by comparing a signal strength of the extracted signal to an interference signal threshold.

10. The method of claim 9, wherein the extracting comprises cancelling both a signal transmitted by an earth station and a signal transmitted by a space station as signals associated with the terrestrial communication network.

11. The method of claim 9, wherein the detecting comprises, when the signal strength of the extracted signal is greater than the interference signal threshold, detecting the interference state.

12. The method of claim 11, wherein the detecting comprises comparing a signal strength associated with the terrestrial communication network for each of frequency slots included in the frequency band to the interference signal threshold.

13. The method of claim 9, further comprising:
calculating a frequency slot corresponding to a minimum signal strength associated with the terrestrial communication network, and newly allocating the frequency slot to the satellite communication network so that the frequency slot is preferentially used by the satellite communication network, when the interference state is detected.

14. The method of claim 9, wherein the detecting comprises determining the interference signal threshold based on geographic information, neighboring building information, location information of a terrestrial radio station, atmospheric environment information and a performance of a communication apparatus.

15. The method of claim 9, wherein the receiving comprises newly receiving the signals in real time or based on a predetermined period, and
wherein the detecting comprises, when the signals are newly received, newly detecting the interference state.

16. An interference signal receiving device comprising:
at least one processor configured to separate a signal of a terrestrial radio station from received signals, to analyze information about usage of each of frequency slots in which the signal of the terrestrial radio station is being transmitted and received, and to allocate a frequency slot for minimum frequency interference among the frequency slots to a satellite communication network signal.

17. The interference signal receiving device of claim 16, wherein the at least one processor is configured to analyze information about usage of the frequency slots by comparing a signal strength of the terrestrial radio station corresponding to the frequency slot to a predetermined threshold.

18. The interference signal receiving device of claim 17, wherein the at least one processor is configured to allocate the frequency slots to the satellite communication network signal in an ascending order of signal strengths of the terrestrial radio station.

19. The interference signal receiving device of claim 16, further comprising:
a communicator configured to transmit and receive the satellite communication network signal and to receive a terrestrial communication network signal.

20. The interference signal receiving device of claim 19, wherein the communicator is configured to receive a leak component of a transmitted signal, and the at least one processor is configured to cancel the leak component and to separate the signal of the terrestrial radio station.
